(19) United States
(12) Patent Application Publication
(10) Pub. No.: US 2006/0112901 A1
(43) Pub. Date: Jun. 1, 2006

(54) Electronic pet containment system with improved transmitter with constant field generation

(76) Inventor: David Rogers Gomez, Mount Joy, PA (US)

Correspondence Address: Jacobson Holman;Professional Limited Liability Company, 400 Seventh Street, N.W., Washington, DC, 20004-2218, US

(21) Appl. No.: 10/989,101

(22) Filed: Nov. 16, 2004

(51) Int. Cl. A01K 15/04

(52) U.S. Cl. 119/721

(57) ABSTRACT

An electronic animal containment or confinement system that contains a transmitter which generates a regulated signal through a boundary antenna made from a buried wire. The regulated signal creates a field signal of a predetermined width regardless of the length of the wire used to define the boundary antenna. The field signal is received by a receiver worn by a dog. If the dog gets too close to the field signal, the receiver generates a current that passes across a pair of probes that contact the skin of the dog in order to give the dog a shock. This represents a form of training to teach the dog to respect an electrified boundary formed by the buried wire. There is also provided a system for protecting a transmitter in a pet confinement system against lightning strikes.

### BACKGROUND OF THE INVENTION

1. Field of the Invention

The present invention relates to an electronic animal containment or confinement system and, more specifically to a pet confinement system that contains a transmitter which generates a regulated signal through a boundary antenna made from a buried wire. The regulated signal creates a field signal of a predetermined width regardless of the length of the wire used to define the boundary antenna.

2. Description of Prior Art

Over the years, electronic animal containment systems have become very popular because they use electronic signals traveling though a buried wire to create a boundary defining a predetermined area within a property. In this way, the property owner does not have to erect a fence in order to ensure that an animal is confined within a desired space.

In a typical electronic animal confinement system, a boundary signal emitter wire in the form of a boundary antenna is buried along the perimeter of a predetermined area of real property or ground in which a pet, such as a dog, is to be confined. A transmitter typically placed in a house or garage is electronically connected directly to the boundary antenna to energize the antenna with a magnetic field signal generated in the transmitter. The wire radiates the magnetic field signal to electronically define an imaginary “boundary” coincident with the wire. A receiver worn about the neck of the dog responds to the radiated signal as the dog approaches the perimeter boundary set up by the boundary antenna. The receiver includes circuitry designed to provide a shock to the dog to cause the dog to move away from the perimeter boundary. As a result, the dog may be kept in the yard without the need for a fence.

One well-known pet containment system is manufactured by Woodstream Corporation of Lititz, Pa. The pet containment system comes in two embodiments. The first is known as the 5140 Fence Free Pet Containment System and the second is known as the 5132 Fence Free Deluxe Pet Containment Systems. Both of these systems provide humane electrical stimulation in a safe and effective way to train a dog to stay within the boundaries of a yard.

While systems such as the ones mentioned above have met with great success, there is nevertheless room for improvement. One area where improvement is needed is in creating a magnetic force field of constant magnitude. In prior art systems, signal field width varies according to several factors, including the length and gauge of the wire defining the boundary antenna. In order to normalize the signal field width for installations of any size, a variable resistance must be added to the loop wire that defines the boundary antenna. This resistance must be added in series with the loop wire and the terminals of the transmitter. In prior art systems, the resistance may be added by use of discrete resistive elements or thorough incorporation or a potentiometer into the transmitter circuitry. No automatic adjustment system exists.

Also in stormy weather, the wire boundary antenna acts not only as a emitter of the magnetic field boundary signal but also as a vehicle for attracting lightening. Should lightening strike at or near the wire, the transmitter circuitry may be damaged or destroyed.

The present invention is directed toward solving these problems.

### SUMMARY OF THE INVENTION

The basic elements of the inventive pet confinement system consist of a receiver that is secured to a collar that is worn by a dog around its neck. The receiver contains two probes that make contact with the skin of the dog so that when the dog gets too close to an electrified boundary, a shock is created within the receiver and passed through the probes into the dog as way to alert the dog that behavior such as approaching the fence should not be done. The receiver also contains a charger receptacle that mates with a complementary connection provided in a transmitter. It is the transmitter which is the subject of this invention.

The installation of a pet confinement system according to the subject invention begins by creating a boundary providing an area within which a dog is free to roam. In its simplest form, the pet confinement system comprises a wire that is buried in the ground in a loop with the ends of the wire being connected to the inventive transmitter. In this way, the boundary is defined about the entire property and the dog is free to roam anywhere within that boundary.

The inventive transmitter contains an input jack which accommodates a connection plug from a portable transformer in order to provide an input voltage for the system. Through the use of a full wave bridge rectifier, the input voltage can be AC or DC, but is preferably DC. The rectifier yields a DC voltage that passes through a voltage regulator which has an output port that provides operating voltage to circuit elements within the system.

The heart of the inventive transmitter is a microcontroller that provides various control signals to a voltage adjuster. An EEPROM is used to program a desired identification code (ID) which matches a comparable identification code set in the receiver that is worn by the dog. This identification code is constantly transmitted to a boundary antenna under the direction of the controller so that the receiver is able to detect and pick up the information that is also contained within the signal that carries the ID.

Also forming part of the invention is the boundary antenna which is made up of a wire that is buried in the ground. This boundary antenna transmits information from the microcontroller that includes the ID along with other information to cause the receiver to respond in different ways. One end of the boundary antenna is connected to a switch that passes through an arrangement of resistors to signal ground (a common electrical point on the Printed Circuit Board). The other end of the boundary antenna is connected to the output of an adjustable voltage regulator. This regulator has an input for receiving an input voltage Vcc from the full-wave bridge rectifier. The regulator also contains an adjustment port for receiving a signal from the voltage adjuster in order to change the magnitude of the output voltage appearing at the output of the regulator. The inventive circuit also includes an operational amplifier (OP AMP) that is used to amplify a voltage signal which represents the voltage passing through the resistor arrangement when the switch is on. The voltage signal is amplified by the OP AMP to a usable value and then placed into an A-to-D converter housed in the microcontroller. The transmitter also contains a switch array made up of a series of six push-button switches that are used to cause the microcontroller to ultimately adjust the current passing through the boundary antenna to yield a magnetic field of desired width appearing around and about the wire forming the boundary antenna.

In order to constructively measure the current flowing through the wire, set points are used. A set point is simply an A-to-D converter count which represents the desired loop current for a field width setting. Each of the five field width settings has its own set point. The set points were calculated using a spreadsheet and are based on an amplifier gain of 40. The set points are 54 for a field width of 1.5 ft. and an average loop current of 80 milliamps, 95 for a field width of 2.5 ft. and an average loop current of 140 milliamps, 124 for a field width of 3.25 ft. and an average loop current of 180 milliamps, 149 for a field width of 4.0 ft. and an average loop current of 220 milliamps, and 190 for a field width of 5.0 ft and an average loop current of 310 milliamps.

When a push-button switch is selected, evidencing a desired field width across the wire making up the boundary antenna, the microcontroller puts out a signal into the voltage adjuster which in turn causes the voltage regulator to put out an output current that passes through the boundary antenna. The desired set point count is monitored in the microcontroller and the microcontroller looks to see if the count represents a desired field width. If the count is too low, then the microcontroller causes the voltage adjuster to increase the output voltage from the voltage regulator. This interaction takes place until the microcontroller gets a set point reading from the data passing through the A-to-D converter that equals or exceeds the predetermined set point value for a desired field width. At that point, the microcontroller no longer yields signals for changing the voltage output of the voltage regulator and the field width passing through the wire of the boundary antenna remains at the desired value.

By virtue of the foregoing, there is thus provided an electronic animal confinement system with an improved transmitter that provides advantages in performance and utility over prior art systems.

Thus, it is an object of the present invention to provide an electronic animal confinement system that has an improved transmitter for providing a signal through a boundary antenna so that the field strength emanating from the boundary antenna is at a predetermined value regardless of the length of the antenna.

It is another object of the present invention to provide an improved system for protecting a transmitter in a pet confinement system against lightning strikes.

These and other objects and advantages of the present invention shall be made apparent from the accompanying drawings and the following detailed description.

### BRIEF DESCRIPTION OF THE DRAWINGS

The accompanying drawings which are incorporated in and constitute a part of the specification illustrate embodiments of the invention and together with a general description of the invention given above and the detailed description given below serve to explain the principles of the invention.

FIG. 1 is a diagrammatic view of a property showing an installation of the subject invention.

FIG. 1A is a diagrammatic view of the dog shown in FIG. 1.

FIG. 2A is a perspective view of a receiver used in the inventive pet containment system.

FIG. 2B is a plan view of the receiver of FIG. 2A mounted on a collar worn by a pet.

FIG. 3 is a plan view of the casing for a transmitter incorporating the present invention.

FIG. 4 is a block diagram of an embodiment of the present invention.

FIG. 5 is a circuit diagram of the embodiment of the present invention shown in FIG. 4.

### DETAILED DESCRIPTION OF THE INVENTION

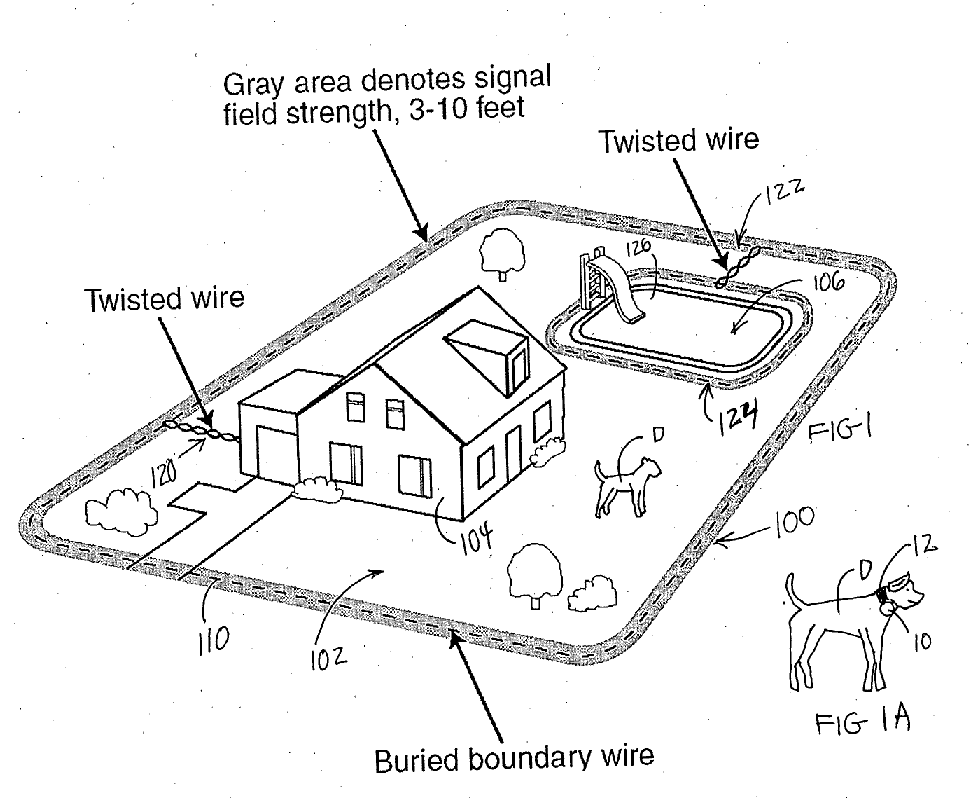

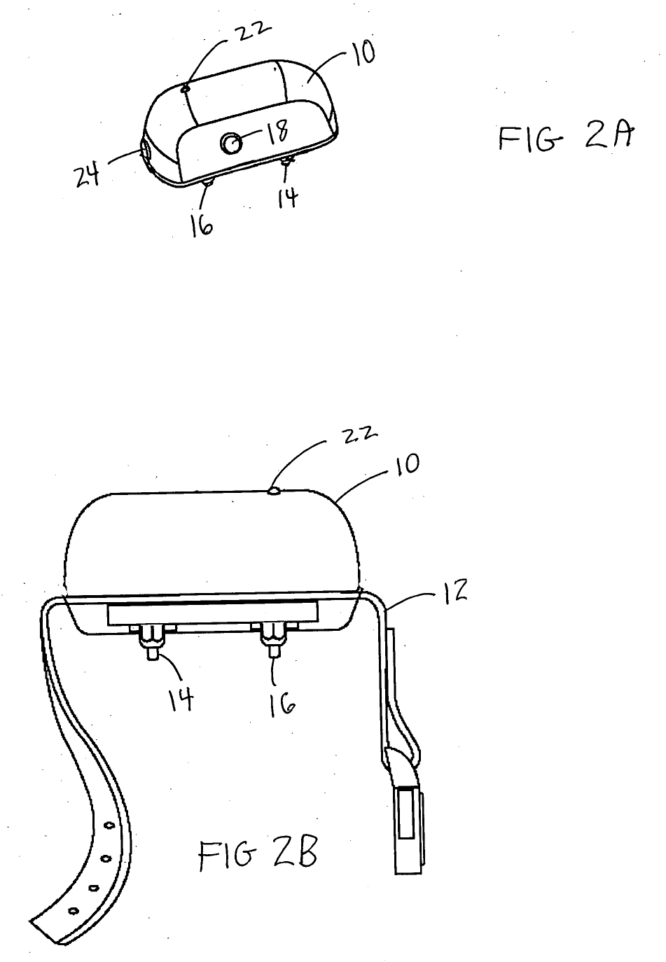

With reference to FIGS. 1 through 3, the basic elements of the inventive pet confinement system are shown. FIGS. 1A, 2A, 2B and 3 generally show a receiver 10 that is secured to a collar 12 that is worn by a dog D around its neck. The receiver contains two probes 14 and 16 that make contact with the skin of the dog so that when the dog gets too close to an electrified boundary, a shock is created within the receiver 10 and passed through the probes 14 and 16 into the dog as way to alert the dog that behavior such as approaching the fence should not be done. The receiver 10 also contains a charger receptacle 18 that mates with a complementary connection provided in the transmitter 20, which is the subject of this invention. The receiver 10 contains a light emitting diode (LED) 22 which indicates when the receiver is functioning and an on/off switch 24 for placing the receiver in an on position and in a desired mode of operation. One such receiver that is contemplated to be used in the present invention is that provided in the Woodstream 5140 Fence Free system. The receiver is discussed in greater detail at the Havaheart website having URL: www.havahart.com, the discussion of which is incorporated by reference herein.

FIG. 1 shows a diagram for the installation of a pet confinement system according to the subject invention. Most often the pet confinement system is used in the context of creating a boundary 100 for providing an area 102 within which a dog D is free to roam. Most often the boundary is set up about a structure such as a house 104. Frequently, a boundary area 102 contains additional areas such as 106 which are areas where the animal should not roam.

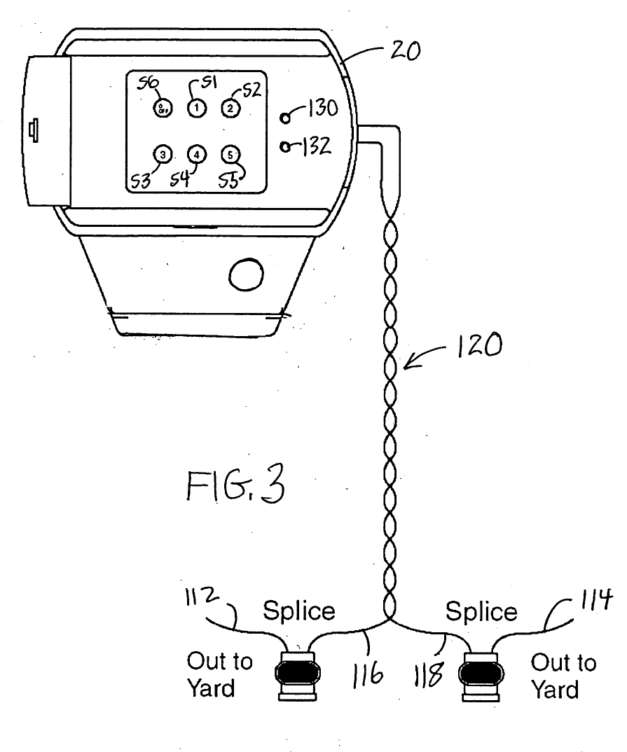

In its simplest form with reference to FIGS. 1 and 3, the pet confinement system comprises a wire 110 that is buried in the ground in a loop with the ends of the wire 112 and 114 being connected to a wire pair 116 and 118 that is twisted in the manner shown in FIG. 3 and identified as 120 and terminating in ends 116 and 118 secured to input terminals provided on the transmitter 20. The twisted wires are used to cancel the magnetic field that normally flows through the wire when it is being used as a single strand to define the boundary 100. The same concept of the twisted wire can be used such as shown by the use of twisted pair 122 to cancel the field which then makes conductive contact with the wire 124 that surrounds a pool 126 in area 106. In this way, the boundary 100 is defined about the entire property and the dog is free to roam anywhere within that boundary. At the same time an inner boundary 124 is defined within the boundary 100 to provide an area 106 that the dog is not permitted to enter.

The transmitter 20 also contains six push-button switches S1 through S6 that are used to control the amount of the current passing through the boundary wire 110. Switch S6 turns the system on and off and causes an LED 130 to light when the system is on. Switches S1 through S5 place the transmitter into a mode where a signal is passed through the wire 110 to generate a magnetic field having a predetermined width. In the present invention, pushing switch S1 causes the transmitter 20 to emanate a signal that creates a field width with a radius of 1.5 ft. In turn, pushing switch S2 yields a field width of 2.5 ft. whereas pushing switch S3 yields a field width of 3.25 ft. Finally, pushing switch S4 yields a field width of 4.0 ft. and pushing switch S5 yields a field width of 5.0 ft.

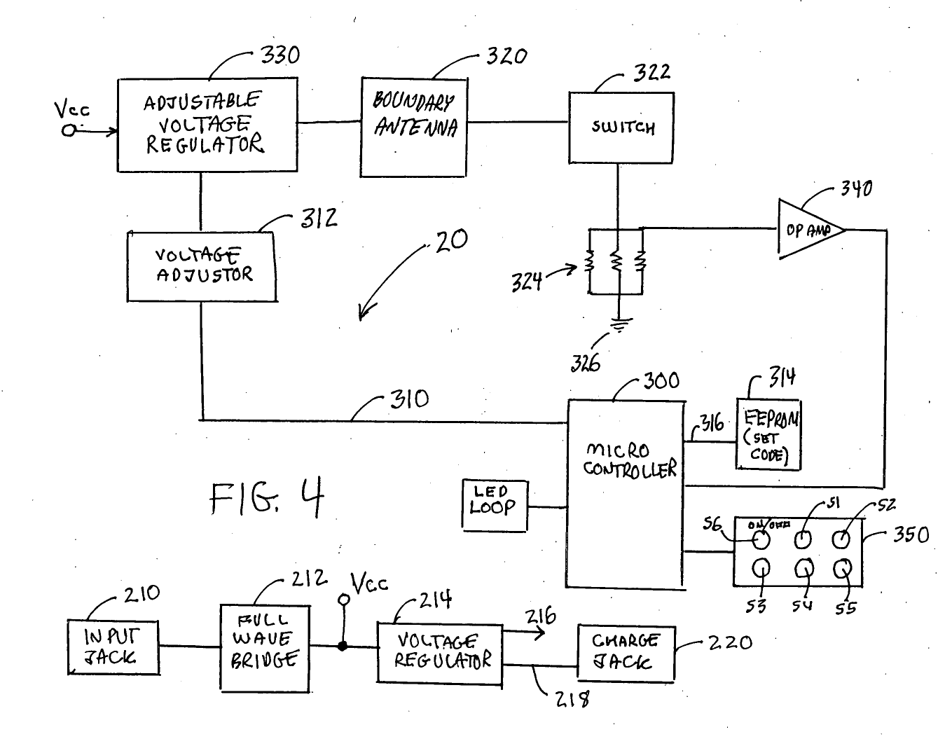

FIG. 4 shows a general block diagram of the elements that constitute the inventive transmitter 20. The transmitter contains an input jack 210 which accommodates a connection plug from a portable transformer (not shown) in order to provide an input voltage for the system. Through the use of a full wave bridge rectifier 212, the input voltage can be AC or DC, but is preferably DC. The rectifier yields a DC voltage, Vcc, that passes through a voltage regulator 214 which has an output port 216 that provides operating voltage to circuit elements within the system. The voltage regulator also has an output 218 connected to a charge jack 220 for mating with the charger receptacle 18 in the receiver 10 in order to charge a rechargeable battery (not shown) housed in the receiver 10.

The heart of the inventive transmitter 20 is a microcontroller 300 that provides various control signals on lines 310 to a voltage adjuster 312. EEPROM 314 is used to program a desired identification code which matches a comparable identification code set in the receiver 10 that is worn by the dog D. When the EEPROM is operating, the identification code (ID) is transmitted to the microcontroller 300 through data lines 316. This identification code is constantly transmitted to boundary antenna 320 under the direction of controller 300 as will be explained hereinafter so that the receiver is able to detect and pick up the information that is also contained within the signal that carries the ID.

Also forming part of the invention is the boundary antenna 320 which is made up of a wire that is buried in the ground in the manner shown in FIG. 1 with reference to the wire 110. This boundary antenna 320 transmits information from the microcontroller 300 that includes the ID along with other information to cause the receiver 10 to respond in different ways. One end of the boundary antenna is connected to a switch 322 that passes through an arrangement of resistors 324 to signal ground 326. The other end of the boundary antenna is connected to the output of an adjustable voltage regulator 330. This regulator has an input for receiving an input voltage Vcc of predetermined value from the output of the full wave bridge 212. The regulator 330 also contains an adjustment port for receiving a signal from the voltage adjuster 312 in order to change the magnitude of the output voltage appearing at the output of the regulator 330. The inventive circuit also includes an operational amplifier (OP AMP) 340 that is used to amplify a voltage signal appearing on line 342 which represents the voltage passing through resistor arrangement 324 when the switch 322 is on. The voltage signal appearing on line 342 is amplified by OP AMP 342 to a usable value and then placed into the microcontroller and passed through an A-to-D converter housed in the microcontroller. The transmitter also contains a switch array 350 made up of a series of six push button switches that are used to cause the microcontroller 300 to ultimately adjust the current passing through the boundary antenna 320 to yield a magnetic field of desired width appearing around and about wire 110. Switch S6 is used to turn the circuit on and off. Switches S1 through S5 are used to cause the microcontroller 300 to control the transmitter circuit in order to create a desired boundary field width around wire 110 that defines the boundary antenna 320.

Basically, when switch 322 is on, the boundary antenna 320 receives a current that passes through the antenna through the switch and then through the resistor arrangement 324 to signal ground. The flow through the boundary antenna creates a magnetic field around the wire that constitutes the boundary antenna. The OP AMP 340 amplifies the voltage across the resistor arrangement 324 to increase the voltage amplitude to a usable value for conversion by the A-to-D converter in the microcontroller 300. For each field width requested by switches S1 through S5, there is a unique current flowing through the wire that is the boundary antenna 320.

In order to constructively measure the current flowing through the wire, set points are used. A set point is simply an A-to-D converter count which represents the desired loop current for a field width setting. Each of the five field width settings has its own set point. The set points were calculated using a spreadsheet and are based on an amplifier gain of 40. The set points are 54 for a field width of 1.5 ft., 95 for a field width of 2.5 ft., 124 for a field width of 3.25 ft., 149 for a field width of 4.0 ft., and 190 for a field width of 5.0 ft.

As will be explained in greater detail hereinafter, when a push-button switch is selected, evidencing a desired field width across the wire making up the boundary antenna, the microcontroller 300 puts out a signal on lines 310 into a voltage adjuster 312 made up of resistors and transistor switches. The adjuster, in turn, causes the voltage regulator 330 to put out an output voltage that passes through the boundary antenna 320. The actual loop current is monitored in the microcontroller and the microcontroller looks to see if the count represents a desired field width. If the count is too low, then the microcontroller causes the voltage adjuster 312 to increase the output voltage from the voltage regulator 330. This interaction takes place until the microcontroller A-to-D converter reading equals or exceeds the predetermined set point value for a desired field width. At that point, the microcontroller no longer yields signals for changing the voltage output of the voltage regulator and the field width passing through the wire of the boundary antenna is at the predetermined desired value.

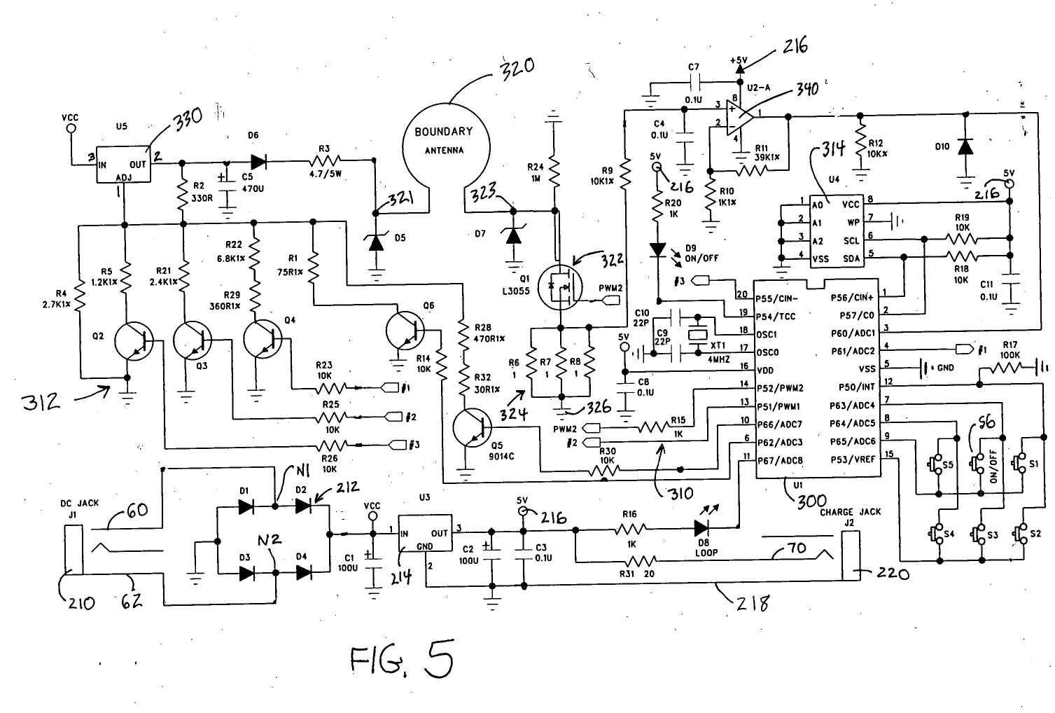

Having covered the general operation of the transmitter, the detailed operation of the circuitry that constitutes the FIG. 4 embodiment of the present invention will now be described with reference to FIG. 5 with like reference numerals denoting like elements to those described in the other figures.

FIG. 5 is a schematic diagram of a preferred embodiment of the present invention. At the heart of the system is microcontroller 300. Six push-button switches S1-S6 are connected to the microcontroller 330. Switches S2, S3 and S4 share a common connection with pin 15 of controller 300, whereas, switches S1, S5 and S6 share a common connection with pin 9 of controller 300. In turn, the other connections of the switches are as follows: switches S4 and S5 are connected to pin 8; switches S3 and S6 are connected to pin 7; and switches S1 and S2 are connected to pin 12.

EEPROM 314 has pins 1-4 connected to ground. The EEPROM also has pin 7 connected to ground. Pin 8 is connected to the output 216 of voltage regulator 214. Pins 5 and 6 of EEPROM 314 through resistors R18 and R19, respectively, are connected to output 216 which in turn are connected to ground through capacitor C11. Pins 5 and 6 are connected to pins 1 and 2, respectively, of controller 300.

With regard to the power supply aspects of the present invention, FIG. 5 shows diodes D1-D4 arranged as a full wave bridge rectifier. DC jack 210 has one conductor 60 connected to node N1 formed between the cathode of diode D1 and the anode of diode D2 and the other conductor 62 connected to node N2 formed between the cathode of diode D3 and the anode of diode D4. The anodes of diodes D1 and D3 are connected to ground. The cathodes of diodes D2 and D4 are connected to the input pin 1 of rectifier 214. Pin 1 of rectifier 214 is also connected to ground through capacitor C1.

Output pin 3 of rectifier 214 is connected to ground through two parallel capacitors C2 and C3. Pin 3 also provide a 5 V DC power source. Pin 2 of rectifier 214 is connected to ground. Pin 3 of rectifier 214 is connected in series with resistor R16 and LED D8 to pin 11 of controller 300. Finally, pin 3 is connected to conductor 70 of charge jack 220 through resistor R31. The other conductor 218 of jack 220 is connected to ground.

Turning now to transistors Q2-Q6, these transistors have their bases connected to controller 300 in the following way: transistor Q2 has a base connection to pin 20 of controller 300 in series with resistor R26; transistor Q3 has a base connection to pin 13 of controller 300 in series with resistor R25; transistor Q4 has a base connection to pin 4 of controller 300 in series with resistor R23; transistor Q5 has a base connection to pin 10 of controller 300 in series with resistor R30; and transistor Q6 has a base connection to pin 6 of controller 300 in series with resistor R14.

The emitters of transistors Q2-Q6 are connected to ground. The bases of transistors Q2-Q6 are connected to pin 1 of the regulator 330 via series resistors R5, R21, R22, R28, and R1, respectively. Resistor R4 is connected to ground and pin 1 of regulator 330.

Pin 2 of regulator 330 is connected to pin 1 of regulator 330 via resistor R2. Pin 2 is also connected to ground via capacitor C5 and to the anode of diode D6. The cathode of diode D6 is connected to terminal 321 of boundary antenna 320 via series resistor R3. Terminal 321 is also connected to ground via transzorb D5. In like manner, terminal 323 of boundary antenna 320 is connected to ground via transzorb D7. Terminal 323 is connected to ground via resistor R24 and to the collector of transistor 322. In turn, transistor has its base connected to pin 14 of controller 300 via resistor R15, and its emitter connected to ground via the parallel arrangement of resistors R6-R8.

Transzorbs D5 and D7 are transient voltage suppressors such as those bearing product number SMBJ12A made by Fairchild Semiconductor Corporation, www.fairchildsemi.com. The transzorbs provide protection for the transmitter circuitry from transients caused by lightning strikes.

Pins 17 and 18 connect to crystal XT1 and to ground via capacitors C9 and C10, respectively. Pin 16 is connected to voltage source 216 and to ground via capacitor C8. Also pin 19 is connected to the cathode of LED D9 whose anode is connected to voltage source 216 via resistor R20. Finally, pin 12 of controller 300 is connected to ground via resistor R17.

The emitter of transistor 322 is connected to pin 3 of OP AMP 340 via resistor R9. Pin 2 of OP AMP 340 is connected to ground via resistor R10 and to pin 1 via resistor R11. Pin 5 of OP AMP 340 is connected to ground via capacitor C7 and to 5 V source 216. Pin 1 of OP AMP 340 is connected to pin 3 of controller 300 and to ground via resistor R12.

As explained before, the heart of the inventive circuit is the microcontroller 300. The microcontroller is an eight bit microcontroller developed with low power and high speed CMOS technology. One such controller is that made by Elan Micro Electronics Corp., Hsinchu City, Taiwan and bearing product designation number EM78P458.

As stated before, six push buttons S1 through S6 are connected to the microcontroller 300 to provide controlling inputs. Switch S6 turns the system on and off. Switches S1 through S5 provide an input to cause the microcontroller to adjust the field width around the boundary antenna 320. The microcontroller 300 executes a program to carry out specific actions based upon which of the buttons is pressed. When a button is pressed, the microcontroller runs a program and outputs analog control signals to the five transistors Q2 through Q6, which are in the voltage adjuster. In a preferred embodiment the transistors are NPN type switching transistors.

A preferred embodiment of EEPROM 314 bears Model Number AT24C04 made by Atmel Corp., San Jose, Calif., www.atmel.com. The EEPROM is an electrically erasable and programmable read only memory organized as 512 words of eight bit each.

Light emitting diodes D8 (132) and D9 (130) are contained on the exterior shell of the transmitter 20 and are used to indicate certain conditions of the transmitter. In particular, LED D8 lights to indicate that the boundary antenna is connected to the transmitter and operative. LED D9 indicates whether the transmitter is on or off Both of the LEDs are activated by signals emanating from the microcontroller 300.

The voltage regulator 214 in a preferred embodiment bears product designation number LM7805CT and is manufactured by National Semiconductor Corp., www.national.com. Voltage regulator 214 regulates the power to power up the remaining devices in the circuit such as OP AMP 340, the microcontroller 300, the EEPROM 314, and other items in the circuit.

Looking now at the programmable voltage regulator 330, this device in a preferred embodiment bears product designation number LM317 and is made by Motorola, Inc., www.motorola.com-. The output voltage of the regulator designated as Vₒᵤₜ can be solved by the formula:
Vₒᵤₜ=1.25v((1+(Variable Resistance/Resistor R2)).
The variable resistance is determined in the voltage adjuster by which of the transistors Q2 through Q6 are conducting in order to selectively place one or more of resistors R4, R5, R21, R22, R1 and R28 in parallel. As can be seen from FIG. 5, the formula in its basic form, when all transistors are not conducting, is: 1.25v (1+(R4/Resistor R1)). This represents the highest voltage output of the voltage regulator 330.

By way of example, let's assume that the microcontroller 300 wishes to provide a certain voltage out from the programmable voltage regulator 330. Further, assume that the desired voltage relies on the parallel arrangement of resistors R4, R22, and R28 in voltage adjuster 312. To accomplish this, the microcontroller puts out activation signals to cause resistors Q4 and Q5 to conduct; thus, placing the resistors R4, R22 and R28 in parallel arrangement and creating an output ratio in order to arrive at the calculation of Vₒᵤₜ. Through the use of the five transistors Q2 through Q6 and the permanent resistor R4, thirty-two different values are possible for Vₒᵤₜ. In this way, for an initial value, all of the transistors are conducting so that all of the resistors are arranged in parallel to produce the lowest Vₒᵤₜ. Through the output of the opt amp 340, the ADC rating is read in the microcontroller and compared with a desired reading for a given field width in the manner described above concerning the use of set points.

As explained before, transistor Q1 performs two primary functions. First, it is used to complete a path for the boundary antenna and second, to transmit data from the transmitter to the collar worn receiver by making and breaking the loop voltage. This arrangement provides one way communication. This is accomplished by opening and closing the circuit at a specific frequency. In essence, a binary signal is sent to the receiver 10 by the on/off operation of transistor 322. The output port PWM2 of controller 300 turns transistor 322 on and off at a specific rate to create the digital signal passing through the loop antenna 320.

Transistor 322 can also be used in the second mode for calibration to adjust the current passing through the boundary antenna 320 to produce a magnetic field of a predetermined width. In this way, a desired field width can be created. The field width can be known precisely each time a calibration is accomplished. Whether or not the boundary antenna is connected or is in an open circuit condition can also be detected and in this way, control the lighting of the loop LED D9.

Calibration is carried out under several circumstances. The first is when any button is pressed. The second is when the unit is powered up. The third is at regular preset intervals. In a preferred embodiment, the intervals are every five seconds.

When entering the calibration phase the desired field width must be known. The user can manually select it by pressing any of the field width buttons (1-5) or by using the default setting when the transmitter is powered up. The microcontroller then goes through the following routine:
1. Set the programmable voltage source to the lowest output voltage (Q2-6 ON). Turn the LOOP LED off.
2. Turn Q1 ON. This completes the loop circuit that forms the boundary antenna 320.
3. Take 16 ADC readings and average them. This significantly increases the accuracy of the reading by reducing induced noise picked up by the loop wire from nearby sources.
4. Compare the averaged ADC reading to the set-point:
a. If greater than or equal to the set-point the calibration is successful and complete. Go to Step 5.
b. Increase the programmable voltage source output voltage to the next higher voltage.
   I. Go to Step 3 if all 32 levels have not been tried.
   II. ERROR—All 32 levels have been tried and the set-point has not been reached. The loop is either broken or not connected. Turn the LOOP LED off.
5. Done! Turn Q1 off.

Loop detection is simplified by implementing it in firmware. The loop is either present or not present, based on the existence of loop current. On a periodic basis, perhaps once every five seconds, when data is not being transmitted, the loop can be powered on for a brief instant to determine if loop current is present or not. The loop power would then be turned off by setting Q1 to the off state, and then normal operation can continue. A calibration phase shall begin if the loop present state changes from not present to present.

It is to be understood that the present invention is not limited to the illustrated user interfaces or to the order of the user interfaces described herein. Various types and styles of user interfaces may be used in accordance with the present invention without limitation.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

What is claimed is:

1. A confinement system for confining an animal to a predetermined area on the ground of a property, the confinement system comprising:
a boundary antenna placed in the ground about the periphery of the predetermined area;
a transmitter generating a regulated signal;
means for connecting the transmitter to the antenna for passing the regulated signal through the antenna so that the antenna emanates a field signal of desired width throughout the length of the antenna, regardless of the length of the antenna.

2. The confinement system of claim 1, wherein the boundary antenna has two connection points for connection to the transmitter, and the confinement system further comprises protecting means secured to each connection point for protecting the transmitter from transient voltages.

3. The confinement system of claim 2, wherein the protecting means comprises a transzorb connected to each of the two connection points and signal ground.

4. The confinement system of claim 2, wherein the transient voltages are caused by lightning strikes.

5. The confinement system of claim 1, further comprising:
a receiver worn by the animal for receiving the field signal when the animal gets within the desired width of the field signal; and
means for shocking the animal when the transmitter receives the field signal.

6. A transmitter for use in a pet confinement system with a boundary antenna broadcasting a field signal of predetermined width throughout the length of the antenna, the transmitter comprising:
a voltage regulator for outputting a voltage of desired magnitude;
means for passing the output voltage of the voltage regulator through the boundary antenna to produce the field signal of predetermined width throughout the length of the boundary antenna;
feedback means for measuring the signal in the boundary antenna and providing an input signal;
controller means responsive to the input signal for periodically adjusting the output voltage of the voltage regulator to maintain the magnitude of the field signal at a constant value regardless of the length of the boundary antenna.

7. The transmitter of claim 6 further comprising:
input switch means operatively connected to the controller means for selecting the value of the predetermined width of the field signal.

8. The transmitter of claim 6, wherein the boundary antenna is made of a wire with first and second ends and the feedback means comprises:
a switch connected to the first end of the wire and the other end connected to a resistor arrangement connected to signal ground;
means for producing the input signal which is representative of the voltage across the resistor arrangement.

9. The transmitter of claim 6 wherein the controller means includes:
an A-to-D converter for converting the input signal to a digital signal for use by the controller means in the periodic adjustment of the output voltage of the voltage regulator.

10. An animal confinement system for use with a boundary antenna made of a wire with first and second ends, the animal confinement system comprising:
a transmitter have first and second connectors, the first connector connected to the first end of the antenna and the second connector connected to the second end of wire; and
means secured to each of the first and second connectors for protecting the transmitter from transient voltages.

11. The confinement system of claim 10, wherein the protecting means comprises a transzorb connected to each of the two connection points and circuit ground.

12. The confinement system of claim 10, wherein the transient voltages are caused by lightning strikes.
